(19) United States
(12) Patent Application Publication
(10) Pub. No.: US 2014/0189767 A1
(43) Pub. Date: Jul. 3, 2014

(54) COMMUNICATION DEVICE, TELEVISION RECEIVER, COMMUNICATION SYSTEM, METHOD FOR COMMUNICATION SETTING, PROGRAM, AND RECORDING MEDIUM

(71) Applicant: Ryosuke Ohmae, Osaka-shi (JP)

(72) Inventor: Ryosuke Ohmae, Osaka-shi (JP)

(73) Assignee: SHARP KABUSHIKI KAISHA, Osaka-shi, Osaka (JP)

(21) Appl. No.: 14/237,517

(22) PCT Filed: Apr. 4, 2012
(86) PCT No.: PCT/JP2012/059268

§ 371 Date: Feb. 6, 2014

(30) Foreign Application Priority Data
Aug. 12, 2011 (JP) 2011-177220

(51) Int. Cl. H04N 21/438

(52) U.S. Cl. CPC H04N 21/438
USPC 725/110

(57) ABSTRACT

A monitor includes: an input receiving section for causing a single setting screen to receive an input of respective communication setting values of an STB and a monitor; and a setting section for setting, for each of the STB and the monitor, a corresponding communication setting value of an inputted plurality of communication setting values.

### TECHNICAL FIELD

The present invention relates to a communication device, a television receiver, a communication system, a communication setting method, a program, and a recording medium each of which is capable of carrying out a communication setting with respect to a plurality of communication devices.

### BACKGROUND ART

There has been a conventional and widely-used technique in which an IP address, which is dynamically assigned by a DHCP (Dynamic Host Configuration Protocol), an Auto IP, or the like, is automatically set for a communication device. Use of such a technique in which a communication setting is automatically carried out makes it possible to save a person involved in the communication setting trouble and time. Therefore, various techniques have been devised for automatically carrying out a communication setting.

For example, Patent Literature 1 (listed later) discloses the following technique. According to the technique, in a case where an IP address of a device cannot be obtained from a DHCP server, a temporary IP address is generated based on an IP address of another device which IP address is obtained in advance, and in a case where it is determined that the temporary IP address thus generated is usable, the temporary IP address is set as an own IP address of the device.

Patent Literature 2 (listed later) discloses the following technique. According to the technique, an own IP address is automatically generated with use of a network address of an IP address, which is automatically assigned by a DHCP server.

Patent Literature 3 (listed later) discloses the following technique. According to the technique, an ARP request packet is transmitted to a network based on a temporary subnet mask, which is set immediately before the transmission, and in a case where it is determined that a gateway has returned an ARP reply packet, the temporary subnet mask is set for a novel connection device.

Patent Literature 4 (listed later) discloses the following technique. According to the technique, in a case where a network address assigned to a first router and a network address assigned to a second router match each other, the network address and an IP address each assigned to the second router are changed.

### CITATION LIST

### Patent Literatures

[Patent Literature 1]
Japanese Patent Application Publication, Tokukai, No. 2010-239281 A (Publication date: Oct. 21, 2010)

[Patent Literature 2]
Japanese Patent Application Publication, Tokukai, No. 2008-078990 A (Publication date: Apr. 3, 2008)

[Patent Literature 3]
Japanese Patent Application Publication, Tokukai, No. 2005-236943 A (Publication date: Sep. 2, 2005)

[Patent Literature 4]
Japanese Patent Application Publication, Tokukai, No. 2005-197793 A (Publication date: Jul. 21, 2005)

### SUMMARY OF INVENTION

### Technical Problem

Note here that a communication setting such as a setting of an IP address needs to be carried out, on a network, with respect to a plurality of communication devices so that the plurality of communication devices communicate with each other via the network.

Examples of a method for carrying out such a communication setting include a method for automatically carrying out a communication setting by the DHCP or the Auto IP (described earlier). However, there may be a case where a communication device is in an environment under which a communication setting cannot be automatically carried out, or a case where a user does not desire that a communication setting be automatically carried out. For example, the user who employs a method for automatically carrying out a communication setting spends a relatively long time in automatically obtaining a communication setting. In this case, there may also occur a problem such that a communication setting cannot be automatically obtained due to something wrong with a router that automatically assigns the communication setting. Therefore, instead of employing a method for automatically carrying out a communication setting, some users may employ a method for manually carrying out a communication setting.

In this case, a user needs to manually carry out a communication setting with respect to each of the communication devices by using a communication setting user interface (e.g., a communication setting screen) in accordance with a corresponding communication device. Therefore, the user needs to understand respective methods for operating a plurality of user interfaces and then operate the plurality of user interfaces.

In particular, some communication devices are provided with no communication setting user interfaces. For such a communication device, it is necessary to separately prepare a device including a communication setting user interface, and to manually carry out a communication setting also in this case by use of the device.

As described earlier, in order to manually carry out a communication setting with respect to a plurality of communication devices, a user needs to take trouble, time, and cost for operating a plurality of user interfaces corresponding to the respective plurality of communication devices.

The present invention has been made in view of the above problem, and an object of the present invention is to efficiently and accurately carry out a communication setting with respect to a plurality of communication devices.

### Solution to Problem

In order to solve the above problem, a communication device of the present invention is a communication device capable of communicating with another communication device via a communication network, the communication device including: input receiving means for causing a single setting screen to receive an input of a communication setting value of the communication device and an input of a communication setting value of the another communication device; and setting means for setting the inputted communication setting value of the communication device for the communication device, and setting the inputted communication setting value of the another communication device for the another communication device.

The communication device allows a single communication device to carry out a communication setting with respect to a plurality of communication devices including the single communication device. Therefore, the user, who does not need to operate the plurality of communication devices and a plurality of user interfaces, can carry out the communication setting with respect to the plurality of communication devices without taking trouble and time. In particular, also in a case where the another communication device has no user interface, it is unnecessary to separately prepare and operate another device for carrying out a communication setting with respect to the another communication device, it is possible to carry out the communication setting with respect to the plurality of communication devices without taking trouble, time, and cost. Further, since the single communication device can collectively carry out a change in communication setting with respect to the plurality of communication devices, it is possible to prevent occurrence of a problem such that a communication setting for only one of the plurality of communication devices is changed and the plurality of communication devices cannot communicate with each other.

In particular, since the communication device allows a single setting screen to carry out the communication setting with respect to a plurality of communication devices, it is possible to understand the communication setting for the plurality of communication devices at a glance. For example, there may be a case where in order to carry out a plurality of communication settings, a user may need to input appropriate values while comparing a plurality of communication setting values of the plurality of communication devices such as setting values that need to be identical to each other (e.g., network addresses) and setting values that need to be different from each other (e.g., host addresses). Also in this case, the user can easily make such a comparison without the need of carrying out a an operation which takes trouble and time, and easily causes an error, such as switching of a plurality of screens or notetaking.

Further, a television receiver of the present invention includes the communication device.

The television receiver of the present invention can bring about an effect identical to that brought about by the communication device.

Further, a communication system of the present invention is a communication system including a plurality of communication devices which are capable of communicating with each other via a communication network, the plurality of communication devices including at least one communication device including: input receiving means for causing a single setting screen to receive an input of a communication setting value of the at least one communication device and an input of a communication setting value of another communication device; and setting means for setting the inputted communication setting value of the at least one communication device for the at least one communication device, and setting the inputted communication setting value of the another communication device for the another communication device.

The communication system makes it possible to bring about an effect identical to that brought about by the communication device.

Further, a communication setting method of the present invention is a communication setting method carried out by a communication device capable of communicating with another communication device via a communication network, the communication setting method including: an input receiving step of causing a single setting screen to receive an input of a communication setting value of the communication device and an input of a communication setting value of the another communication device; and a setting step of setting the inputted communication setting value of the communication device for the communication device, and setting the inputted communication setting value of the another communication device for the another communication device.

The communication setting method can bring about an effect identical to that brought about by the communication device by being executed by a communication device.

Further, a program of the present invention is a program for causing a computer to function as the communication device, the program causing the computer to function as each means of the communication device.

The program can bring about an effect identical to that brought about by the communication device by being executed by a computer.

Further, a recording medium of the present invention is a computer-readable recording medium in which the program is recorded.

The recording medium can provide the program which brings about an effect identical to that brought about by the communication device.

### Advantageous Effects of Invention

A communication device, a television receiver, a communication system, a communication setting method, a program, and a recording medium of the present invention allows a single communication device to carry out a communication setting with respect to a plurality of communication devices including the single communication device. Therefore, the user, who does not need to operate a plurality of devices, can carry out the communication setting with respect to the plurality of communication devices without taking trouble and time.

### BRIEF DESCRIPTION OF DRAWINGS

FIG. 1 illustrates a device configuration of a television receiver in accordance with Embodiment 1.

FIG. 2 is a block diagram showing a configuration of a monitor in accordance with Embodiment 1.

FIG. 3 is a block diagram showing a configuration of an STB in accordance with Embodiment 1.

FIG. 4 is a block diagram showing a configuration of the communication setting-related possessed by a control circuit of the monitor in accordance with Embodiment 1.

FIG. 5 is a sequence diagram showing the steps of the communication setting process carried out in the television receiver in accordance with Embodiment 1.

FIG. 6 shows an example of a setting screen for receiving a plurality of communication setting values.

FIG. 7 shows an example of an input of a plurality of communication setting values.

FIG. 8 shows an example of an input of a plurality of communication setting values.

FIG. 9 shows an example of an error message for notifying that a plurality of communication setting values are incorrect.

FIG. 10 shows an example of a method for notifying a part in which an inputted communication setting value is incorrect.

FIG. 11 is a block diagram showing a configuration of communication setting-related functions possessed by a control circuit of a monitor in accordance with Embodiment 2.

FIG. 12 is a block diagram showing a configuration of communication setting-related functions possessed by a control circuit of a monitor in accordance with Embodiment 3.

FIG. 13 shows an example of an automatic input of a communication setting value.

FIG. 14 shows an example of an automatic input of communication setting values.

FIG. 15 shows an example of an automatic input of communication setting values.

### DESCRIPTION OF EMBODIMENTS

Embodiments of the present invention are described below with reference to the drawings.

### Embodiment 1

### Outline of Television Receiver 100

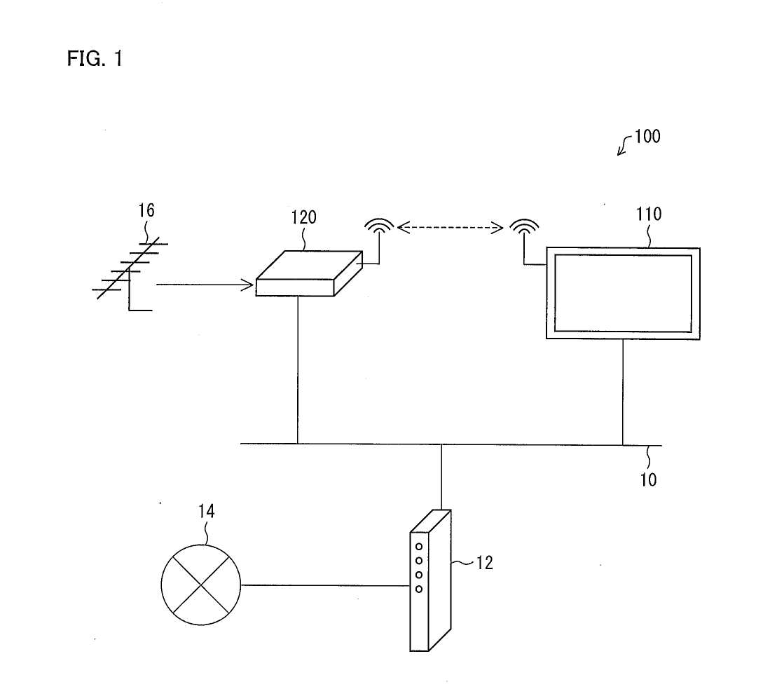

First, the following description discusses, with reference to FIG. 1, an outline of a television receiver 100 in accordance with Embodiment 1. FIG. 1 illustrates a device configuration of the television receiver 100 in accordance with Embodiment 1. The television receiver 100 illustrated in FIG. 1 is capable of receiving various pieces of content that are transmitted as broadcast waves of terrestrial digital broadcasting or broadcast waves of BS (broadcasting satellite)/CS (communications satellite) digital broadcasting via a corresponding tuner (a terrestrial digital tuner or a BS/CS digital tuner), and playing back the content.

The television receiver 100 includes a monitor 110 and an STB (set top box) 120 as communication devices. The STB 120 and the monitor 110 are each connected to a LAN 10 and can communicate with each other via the LAN 10.

Assuming that the STB 120 and the monitor 110 are connected to each other in an identical network (a range in which the STB 120 and the monitor 110 can directly communicate with each other), the STB 120 and the monitor 110 search for each other in accordance with a broadcast-based or a multicast-based protocol and find each other to communicate with each other.

The STB 120 includes a tuner that receives terrestrial digital broadcasting and BS broadcasting. The STB 120 uses the tuner to obtain content received by a DTV/BS antenna 16. Then, the STB 120 transmits the content thus obtained to the monitor 110 via the LAN 10. Then, the monitor 110 displays the content thus obtained on a display.

Embodiment 1 employs a liquid crystal display as the monitor 110. However, the present invention can employ not only the liquid crystal display but also an organic EL display, a plasma display, a cathode-ray-tube display, or the like.

The STB 120 and the monitor 110 can each be connected to an external device. For example, the STB 120 can be connected to a USB-HDD. The STB 120 can record content in the USB-HDD, and by transmitting, to the monitor 110, the content recorded in the USB-HDD, the STB 120 can cause the monitor 110 to display the content. Similarly, the monitor 110 can be connected to a recorder/player. The monitor 110 can display content that is played back by the recorder/player.

The LAN 10 is connected to the Internet 14 via a router 12. This allows the STB 120 and the monitor 110 to access the Internet 14 via the LAN 10. For example, the STB 120 and the monitor 110 can (i) download content from the Internet 14 and play back the downloaded content, (ii) obtain, from the Internet 14, various pieces of information such as television program information and display the obtained information, and (iii) transmit, to the Internet 14, various pieces of information such as information for entry for a prize competition.

Note that the STB 120 and the monitor 110 of Embodiment 1 are each wire-connected to the LAN 10 with use of a LAN cable. Alternatively, at least one of the communication devices can also be wirelessly connected to the LAN 10 via a wireless access point. In this case, it is possible to provide such a communication device in any place within an area in which the communication device can wirelessly communicate with the wireless access point. A communication standard suitable for wireless communication with a wireless access point can be exemplified by, for example, IEEE 802.11 series.

Further, the STB 120 and the monitor 110 can also directly communicate with each other not via the LAN 10 but via another wireless or wired communication. A user can select, as a communication connection mode between the STB 120 and the monitor 110, a connection mode in which the STB 120 and the monitor 110 are connected via the LAN 10 or a direct connection mode in which the STB 120 and the monitor 110 are connected not via the LAN 10. In a case where the direct connection mode is selected, the STB 120 may be connected to the LAN 10 and function as a wireless access point of the LAN 10. This enables the monitor 110, for example to access the LAN 10 or the Internet via the STB 120.

(Configuration of Monitor 110)

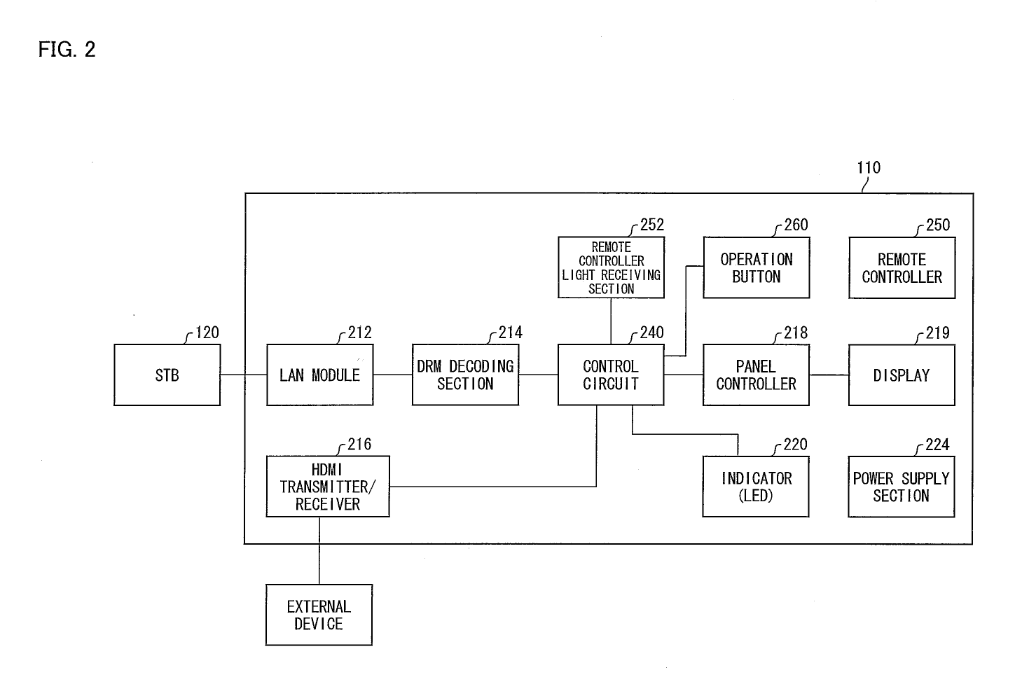

Here, a configuration of the monitor 110 is described with reference to FIG. 2. FIG. 2 is a block diagram showing a configuration of the monitor 110 in accordance with Embodiment 1.

As shown in FIG. 2, the monitor 110 includes a LAN module 212, a DRM decoding section 214, a control circuit 240, a panel controller 218, a display 219, an HDMI transceiver/receiver 216, an indicator 220, a power supply section 224, a remote controller 250, a remote controller light receiving section 252, and operation buttons 260.

The LAN module 212 is a communication interface for carrying out LAN communication. For example, the LAN module 212 receives encrypted data of content transmitted from the STB 120. The encrypted data received by the LAN module 212 is supplied to the DRM decoding section 214. The DRM decoding section 214 decodes the supplied encrypted data so as to obtain an image signal. The image signal obtained by the DRM decoding section 214 is supplied to the panel controller 218. In response to the image signal, the panel controller 218 causes the display 219 to display an image in accordance with the image signal.

The HDMI transmitter/receiver 216 is a communication interface for carrying out communication with an external device such as a recorder or a player.

For example, the HDMI transmitter/receiver 216 receives, from an external device, an image signal of content played back by the external device. As in the case of an image signal of content supplied from the STB 120, the image signal obtained by the HDMI transmitter/receiver 216 is supplied to the panel controller 218. This causes an image corresponding to the image signal to be displayed in a display panel of the display 219.

The power supply section 224 supplies, to each section of the monitor 110, power necessary for an operation of the each section.

The indicator 220 notifies the user of, for example, a state of the monitor 110 by being turned on under control by the control circuit 240.

The remote controller 250, which is provided separately from a body of the monitor 110, carries out various remote operations with respect to the monitor 110.

The remote controller light receiving section 252 receives a remote operation by the remote controller 250 by receiving infrared light emitted from the remote controller 250.

The operation buttons 260, which are provided in the body of the monitor 110, carry out various operations with respect to the monitor 110.

For example, in a case where the user operates the remote controller 250 or the operation buttons 260, the user can subject the television receiver 100 to operations such as turning-on/off of a power supply, volume control, input switching, channel selection, various settings, recording, and playback.

The control circuit 240, which is constituted by, for example, a CPU and a ROM or a RAM, controls the each section of the monitor 110 in a case where the CPU executes a program recorded in the ROM, the RAM, or the like.

(Configuration of STB 120)

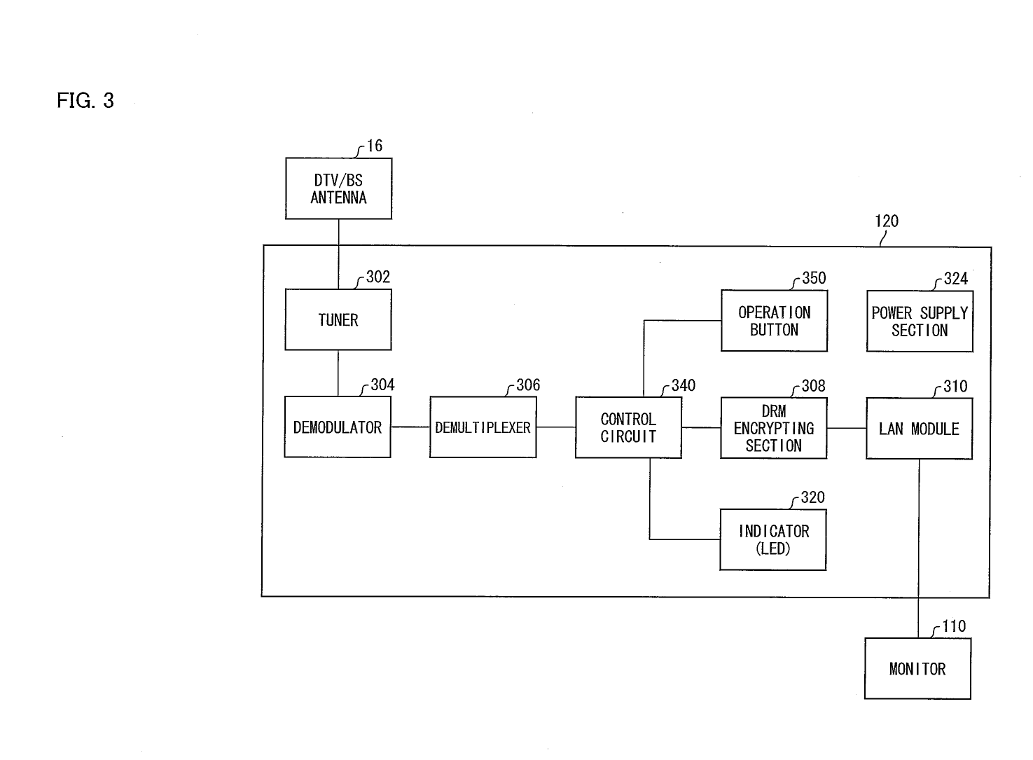

Next, a configuration of the STB 120 is described below with reference to FIG. 3. FIG. 3 is a block diagram showing a configuration of the STB 120 in accordance with Embodiment 1.

As shown in FIG. 3, the STB 120 includes a tuner 302, a demodulator 304, a demultiplexer 306, a control circuit 340, a DRM encrypting section 308, a LAN module 310, an indicator 320, a power supply section 324, and operation buttons 350.

The tuner 302 receives broadcast waves of digital television broadcasting or broadcast waves of BS digital broadcasting from the DTV/BS antenna 16. Image data received by the tuner 302 is supplied to the demodulator 304.

The demodulator 304 demodulates the image data. The image data demodulated by the demodulator 304 is supplied to the demultiplexer 306. The demultiplexer 306 separates an image signal from the image data. The image signal separated by the demultiplexer 306 is supplied to the DRM encrypting section 308. The DRM encrypting section 308 encrypts the supplied image signal so as to obtain encrypted data. The encrypted data obtained by the DRM encrypting section 308 is supplied to the LAN module 310. The LAN module 310 is a communication interface for carrying out LAN communication. The LAN module 310 transmits the supplied encrypted data to the monitor 110.

The power supply section 324 supplies, to each section of the STB 120, power necessary for an operation of the each section.

The indicator 320 notifies the user of, for example, a state of the STB 120 by being turned on under control by the control circuit 340.

The operation buttons 350, which are provided in a body of the STB 120, carry out various operations with respect to the STB 120.

For example, in a case where the user operates the operation buttons 350, the user can subject the STB 120 to operations such as turning on/off of power.

The control circuit 340, which is constituted by, for example, a CPU and a ROM or a RAM controls the each section of the STB 120 in a case where the CPU executes a program recorded in the ROM, the RAM, or the like.

(Communication Setting)

In order for the STB 120 and the monitor 110 to communicate with each other via the LAN 10, it is necessary to carry out a communication setting with respect to each of the STB 120 and the monitor 110. According to the television receiver 100 of the present embodiment, the monitor 110 can collectively carry out the communication setting with respect to each of the STB 120 and the monitor 110. The following description specifically discusses how the monitor 110 carries out the communication setting.

(Communication Setting Function)

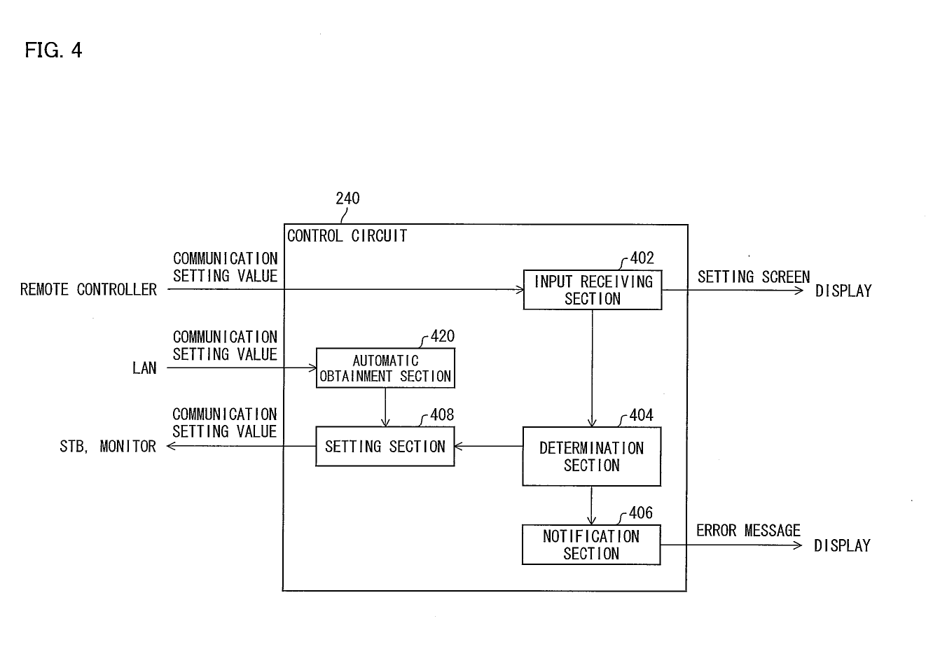

First, the following description discusses, with reference to FIG. 4, communication setting-related functions possessed by the control circuit 240 of the monitor 110. FIG. 4 is a block diagram showing a configuration of the communication setting-related functions possessed by the control circuit 240 of the monitor 110 in accordance with Embodiment 1. As shown in FIG. 4, the control circuit 240 includes, as the communication setting-related functions, an input receiving section 402, a determination section 404, a notification section 406, a setting section 408, and an automatic obtainment section 420.

(Input Receiving Section)

The input receiving section 402 causes a single setting screen to receive an input of respective communication setting values of the STB 120 and the monitor 110. Specifically, the input receiving section 402 causes a setting screen for setting the communication setting values to be displayed in the display 219. The user inputs the communication setting values to the setting screen by operating the remote controller 250.

(Determination Section)

The determination section 404 determines whether or not an inputted plurality of communication setting values are correct. Specifically, there is a correlation among the inputted plurality of communication setting values. By determining whether or not the inputted plurality of communication setting values satisfy the correlation, the determination section 404 determines whether or not the communication setting values are correct.

For example, according to an example of the present embodiment, the plurality of communication setting values include respective IP addresses of the STB 120 and the monitor 110, a net mask, and a gateway. Of these communication setting values, the IP address of the STB 120 is set for the STB 120. The IP address of the monitor 110 is set for the monitor 110. The net mask and the gateway are set for each of the STB 120 and the monitor 110.

Here, by specifying a network address part of the IP address, the net mask specifies a range of the IP address in which range the STB 120 and the monitor 110 can directly communicate with each other in the LAN 10.

That is, the respective IP addresses of the STB 120 and the monitor 110 need to fall within the range of an IP address, which range is specified by the net mask, and be different from each other.

For this reason, the respective IP addresses of the STB 120 and the monitor 110 need to be identical in (1) network address to each other and be different in (2) host address from each other.

Therefore, by determining whether or not the respective IP addresses of the STB 120 and the monitor 110 satisfy both the (1) and (2), the determination section 404 determines whether or not the IP addresses are correct. For example, in a case where the respective IP addresses of the STB 120 and the monitor 110 satisfy both the (1) and (2), the determination section 404 determines that the IP addresses are correct. In a case where the respective IP addresses of the STB 120 and the monitor 110 do not satisfy either one of the (1) and (2), the determination section 44 determines that the IP addresses are incorrect.

(Notification Section)

The notification section 406 is configured to notify the user of a case where the determination section 404 determines that an inputted communication setting value is incorrect.

For example, the notification section 406 causes the display 219 to display a message that an inputted communication setting value is incorrect. Alternatively, the notification section 406 highlights a part of the setting screen in which part an inputted communication setting values is incorrect.

(Setting Section)

The setting section 408 sets, for each of the STB 120 and the monitor 110, a corresponding communication setting value of an inputted plurality of communication setting values.

Specifically, the setting section 408 sets, for a communication setting table included in the STB 120, (i) a net mask and a gateway, (ii) an IP address of the STB 120 as an own address of the STB 120, and (iii) an IP address of the monitor 110 as an IP address of a communication partner.

Meanwhile, the setting section 408 sets, for a communication setting table included in the monitor 110, (i) a net mask and a gateway, (ii) an IP address of the monitor 110 as an own address of the monitor 110, and (iii) an IP address of the STB 120 as an IP address of a communication partner.

This allows the STB 120 and the monitor 110 to communicate with each other via the LAN 10.

(Automatic Obtainment Section)

The automatic obtainment section 420 automatically obtains at least a part of a plurality of communication setting values. According to the example of the present embodiment, a setting for the automatic obtainment is made as a default setting for the STB 120 and the monitor 110. Alternatively, the user can select whether or not the respective IP addresses of the STB 120 and the monitor 110 are automatically obtained. In a case where the setting for the automatic obtainment is made, the automatic obtainment section 420 automatically obtains the IP address of the monitor 110 by a DHCP, an Auto IP, or the like. In this case, the setting section 408 sets the IP address thus automatically obtained as an own IP address of the monitor 110 for the communication setting table included in the monitor 110.

Alternatively, in a case where the user selects the automatic obtainment, the automatic obtainment section 420 sets the automatic obtainment for the STB 120. The STB 120, for which the automatic obtainment has been set as the default setting or by the user, automatically obtains the IP address of the STB 120 by the DHCP, the Auto IP, or the like, and sets the IP address thus obtained as an own IP address of the STB 120 for the communication setting table included in the STB 120.

The STB 120 and the monitor 110, for which the respective settings have been made, search for each other in accordance with a predetermined protocol, and set for the respective communication setting tables, addresses each found as an IP address of a communication partner.

(Steps of Communication Setting Process)

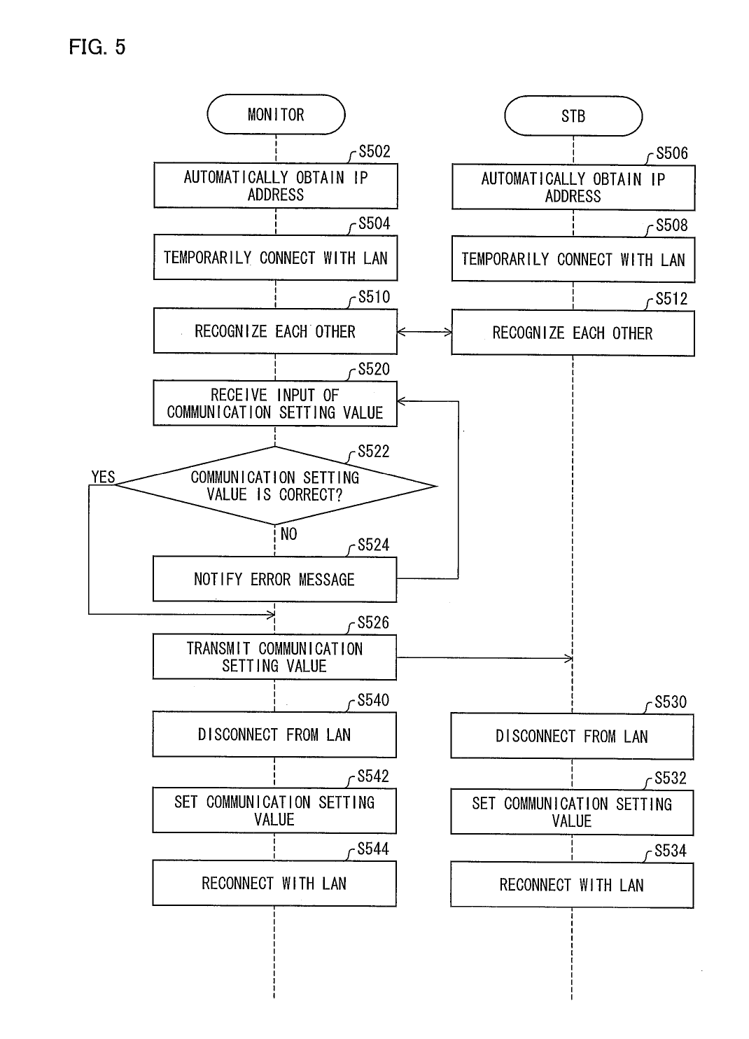

Next, steps of a communication setting process carried out in the television receiver 100 are described with reference to FIG. 5. FIG. 5 is a sequence diagram showing the steps of the communication setting process carried out in the television receiver 100 in accordance with Embodiment 1.

The communication setting process is carried out in, for example, a case where the STB 120 and the monitor 110 are newly connected to communicate with each other, a path by which a communication connection is carried out is switched to the LAN 10, or a communication setting for the LAN 10 is made again. In any case, the television receiver 100 may carry out the communication setting process at a predetermined timing or any timing specified by the user.

(Temporary Connection)

First, the monitor 110 causes the automatic obtainment section 420 to obtain, by the DHCP, the Auto IP, or the like, a temporary IP address for communicating with the STB 120 (Step S502). Then, the monitor 110 temporarily connects with the LAN 10 by use of the IP address thus obtained (Step S504).

Similarly, the STB 120 obtains, by the DHCP, the Auto IP, or the like, a temporary IP address for communicating with the monitor 110 (Step S506). Then, the STB 120 temporarily connects with the LAN 10 by use of the IP address thus obtained (Step 508).

Thereafter, by using, for the LAN 10, respective Mac addresses, for example of the STB 120 and the monitor 110 obtained in advance by, for example, a pairing process, the STB 120 and the monitor 110 each search for respective communication partners and respond to the search, so that the STB 120 and the monitor 110 recognize each other as the respective communication partners (Step S510 and S512).

It goes without saying that the above steps do not need to be carried out in a case where the monitor 110 and the STB 120 are each already connected with the LAN 10 and recognize each other as the respective communication partners.

According to the example of the present embodiment, the setting for the automatic obtainment is made as the default setting, and the setting with which no problem occurs can be commonly used as it is without being changed. Alternatively, a temporary connection may be realized, instead of automatic setting, by setting a particular fixed address determined in advance by setting such a restriction that other device(s) is not connected to the LAN 10.

(Communication Setting)

Subsequently, the monitor 110 causes the input receiving section 402 to receive an input of respective communication setting values of the STB 120 and the monitor 110 (Step S520). Then, the monitor 110 causes the determination section 404 to determine whether or not the plurality of communication setting values inputted at Step S520 are correct (Step S522).

The monitor 110 which has determined at Step S522 that the inputted plurality of communication setting values are incorrect (Step S522: No) causes the notification section 406 to give an error message that the inputted plurality of communication setting values are incorrect (Step S524). Then, the monitor 110 receives an input of a plurality of communication setting values again at Step 520.

Meanwhile, the monitor 110 which has determined at Step S522 that the inputted plurality of communication setting values are correct (Step S522: Yes) causes the setting section 408 to transmit, to the STB 120, a corresponding communication setting value (Step S526).

The STB 120 which has received the corresponding communication setting value temporarily disconnects itself from the LAN 10 (Step S530), sets the communication setting values as communication setting items on the LAN 10 (Step S532), and reconnects itself with the LAN 10 with use of the communication setting values (Step S534).

Similarly, the monitor 110 temporarily disconnects itself from the LAN 10 (Step S540), sets the inputted communication setting values as communication setting items on the LAN 10 (Step S542), and reconnects itself with the LAN 10 with use of the communication setting values (Step S544).

(Example of Setting Screen)

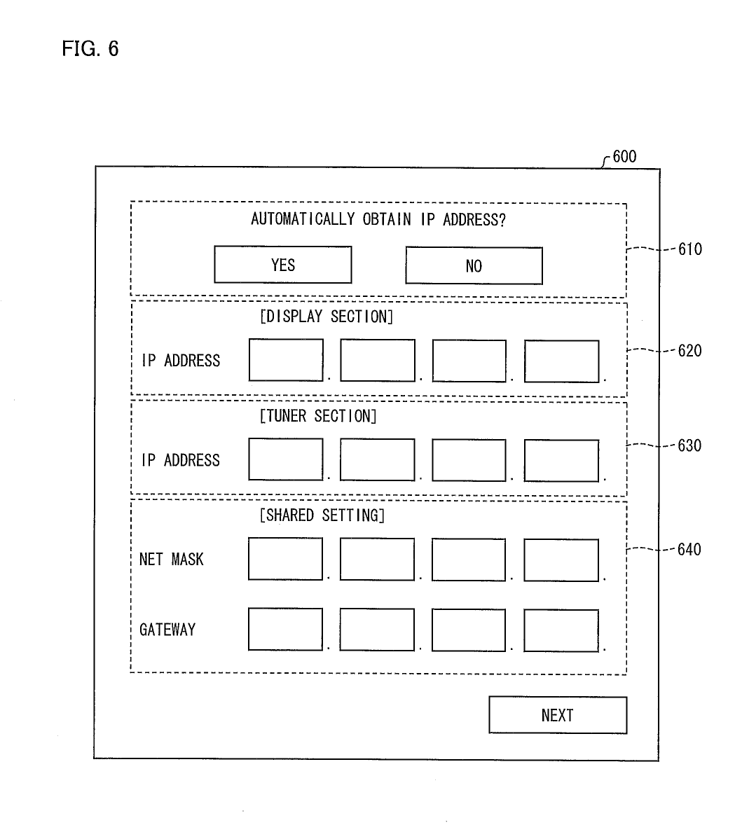

FIG. 6 shows an example of a setting screen for receiving a plurality of communication setting values. A screen 600 shown in FIG. 6 is a setting screen for receiving a plurality of communication setting values. The screen 600 is displayed in the display 219 of the monitor 110 when the input receiving section 402 receives the input of the respective communication setting values of the STB 120 and the monitor 110.

As shown in FIG. 6, the screen 600 has a selection field 610, an input field 620, an input field 630, and an input field 640.

The selection field 610 is provided for selecting whether or not to automatically obtain respective IP addresses of the STB 120 and the monitor 110. The input field 620 is provided for receiving the IP address of the monitor 110. The input field 630 is provided for receiving the IP address of the STB 120.

The input field 630 is provided for receiving respective IP addresses of a net mask and a gateway router, the respective IP addresses being communication setting items shared by the STB 120 and the monitor 110. Note that, only when the LAN 10 is provided with a gateway router, the input field may receive an IP address of the gateway router. It is assumed that the LAN 10 of the present embodiment is provided with no gateway router.

(Examples of Input of Communication Setting Values and Example of Error Message)

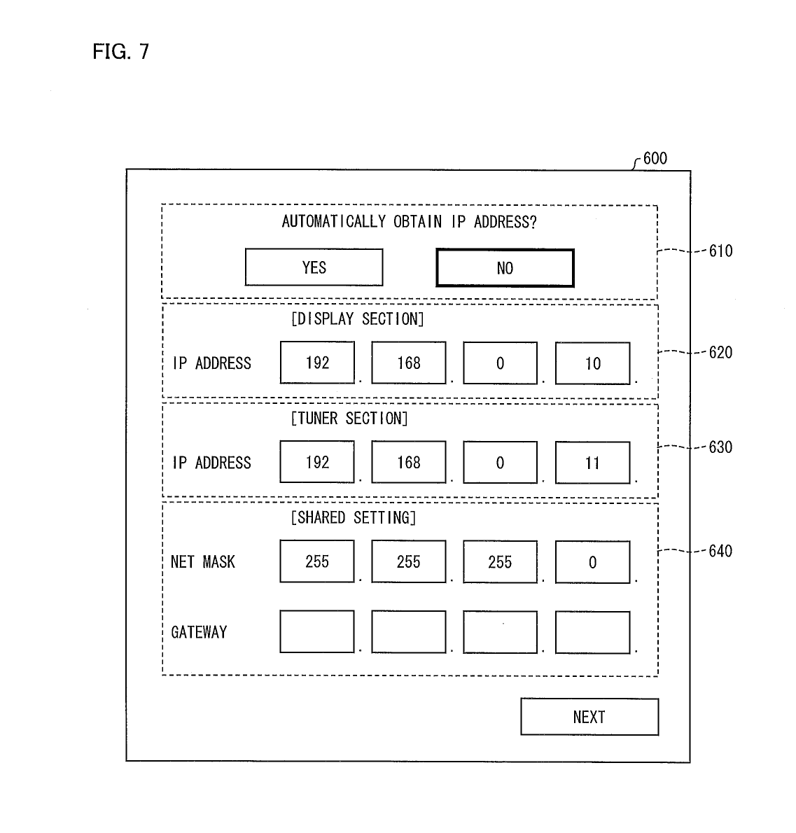

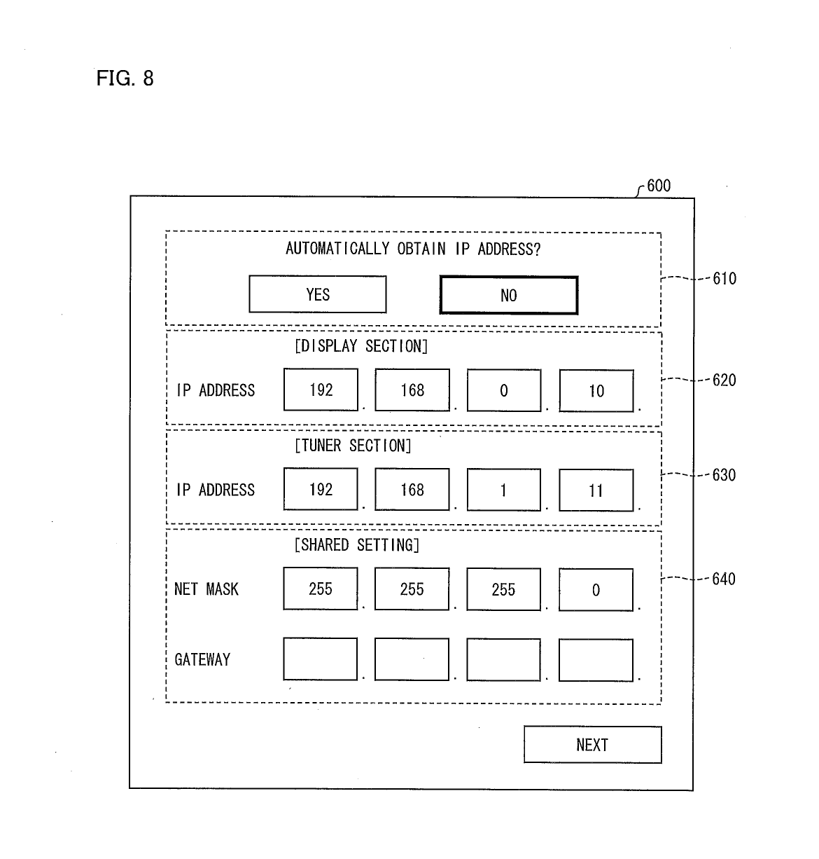

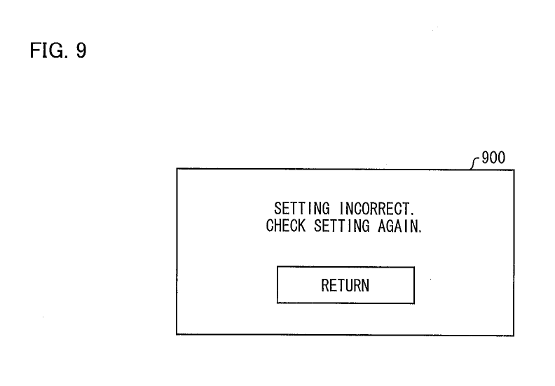

FIGS. 7 and 8 show respective examples of an input of a plurality of communication setting values. FIG. 9 shows an example of an error message for notifying that a plurality of communication setting values are incorrect.

According to the respective examples of FIGS. 7 and 8, the screen 600 described by use of FIG. 6 receives a plurality of communication setting values.

For example, according to the example of FIG. 7, the selection field 610 selects “No” button for not automatically obtaining the IP addresses. The input field 620 receives “192.168.0.10” as the IP address of the monitor 110. The input field 630 receives “192.168.0.11” as the IP address of the STB 120. The input field 640 receives “255.255.255.0” as the net mask shared by the monitor 110 and the STB 120.

Meanwhile, according to the example of FIG. 8, the selection field 610 selects “No” button for not automatically obtaining the IP addresses. The input field 620 receives “192.168.0.10” as the IP address of the monitor 110. The input field 630 receives “192.168.1.11” as the IP address of the STB 120. The input field 640 receives “255.255.255.0” as the net mask shared by the monitor 110 and the STB 120.

When the screen 600 thus receives the plurality of communication values, the determination section 404 of the monitor 110 determines, immediately or at a timing at which “Next” button provided for the screen 600 is pressed, whether or not the plurality of communication setting values are correct.

For example, according to the example of FIG. 7, the determination section 404 determines from a setting of the net mask that the first 24 bits of the IP address serve as a network address. Then, since the IP address of the monitor 110 and the IP address of the STB 120 each have a an identical network address of “192.168.0”, the determination section 404 determines that the IP addresses are correctly set.

In this case, the monitor 110 reflects the plurality of communication setting values in the monitor 110 and the STB 120 without notifying the error message that the plurality of communication setting values are incorrect.

Meanwhile, according to the example of FIG. 8, the determination section 404 determines from the setting of the net mask that the first 24 bits of the IP address serve as a network address (network part of the IP address) and the remaining 8 bits serve as a host address (host part of the IP address). Then, given that the IP address of the monitor 110 and the IP address of the STB 120 have respective different network addresses of “192.168.0” and “192.168.1”, the determination section 404 determines that the IP addresses are incorrectly set.

In response to the determination, the notification section 406 of the monitor 110 displays, in the display of the monitor 110, a screen 900 (see FIG. 9) showing the error message for notifying that the plurality of communication setting values are incorrect. Thereafter, the monitor 110 receives a re-input of a plurality of communication setting values.

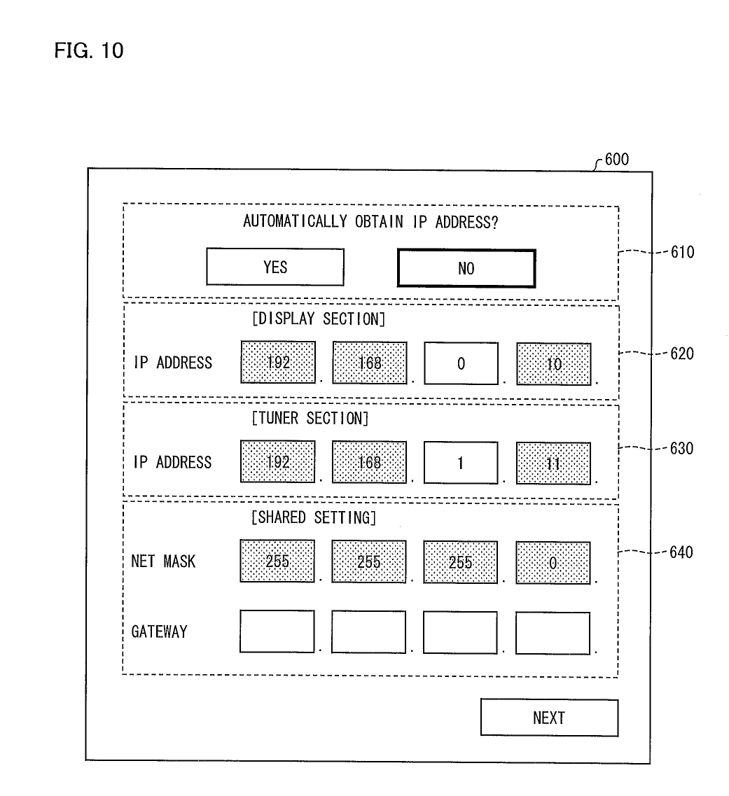

FIG. 10 shows an example of a method for notifying a part in which an inputted communication setting value is incorrect. The notification section 406 of the monitor 110 may notify the user of a part of the inputted plurality of communication setting values for which part the determination section 404 determines that the part is incorrect.

For example, by highlighting, in the setting screen, the part in which an inputted communication setting value is incorrect, the notification section 406 may notify a user of such a part.

According to the example of FIG. 10, as in the case of the example of FIG. 8, while the input field 640 receives “255.255.255.0” as the net mask, the IP address of the monitor 110 and the IP address of the STB 120 have respective different network addresses of “192.168.0” and “192.168.1”. Given this, the determination section 404 determines that the IP addresses are incorrectly set.

For this reason, the screen 600 shown in FIG. 10 is controlled by the notification section 406 so that parts in which respective inputted communication setting values are correct are colored and so that parts in which respective inputted communication setting values are incorrect (the third 8-bit part of the IP address of the monitor 110 which part receives “0” and the third 8-bit part of the IP address of the STB 120 which part receives “1”) are uncolored.

This enables the user to easily understand which part is incorrect. Therefore, the user can input a correct communication setting value accurately and promptly.

Note that according to the example of FIG. 10, the net mask may be incorrectly set. Therefore, the notification section 406 may be configured to highlight the setting of the net mask in addition to/instead of highlighting a part of an IP address.

(Effect)

As described above, the television receiver 100 of Embodiment 1 allows the monitor 110 to carry out the communication setting with respect to each of the monitor 110 and the STB 120. Therefore, the user, who does not need to operate respective interfaces of the monitor 110 and the STB 120, can carry out the respective communication setting with respect to the monitor 110 and the STB 120 without taking trouble and time. In particular, since it is unnecessary to separately prepare and operate a device for carrying out a communication setting for the STB 120, which has no user interface, it is possible to carry out the communication setting with respect to each of the monitor 110 and the STB 120 without taking trouble, time, and cost.

Further, the television receiver 100 of Embodiment 1 also allows an identical setting screen to carry out the communication setting with respect to each of the monitor 110 and the STB 120. This allows an easy comparison of a plurality of communication setting values, e.g., a comparison of the IP addresses or a comparison of the IP addresses and the net mask.

Further, the television receiver 100 of Embodiment 1 allows the screen 600 to receive, one by one, communication setting values shared in the setting screen (respective IP addresses of the net mask and the gateway router). This makes it possible to save a user from inputting shared communication setting values a plurality of times and to prevent an input error such that the monitor 110 and the STB 120 differ in shared communication setting value.

Furthermore, the television receiver 100 of the present embodiment is configured to (i) determine, from one or more inputted communication setting values, whether or not another inputted communication value is correct, and (ii) when it is determined that the another inputted communication setting value is incorrect, to give notification that the another inputted communication setting value is incorrect. Therefore, also in a case where the another communication setting value is inputted incorrectly, without the need of attempting to carry out a communication connection, it is possible to urge a user to correct the another inputted communication setting values.

### Embodiment 2

Next, Embodiment 2 in accordance with the present invention is described below. Since a television receiver 100 of Embodiment 2 is identical to the television receiver 100 described in Embodiment 1 except for the following points, a description thereof is omitted here. The following description discusses points of difference from the television receiver 100 described in Embodiment 1.

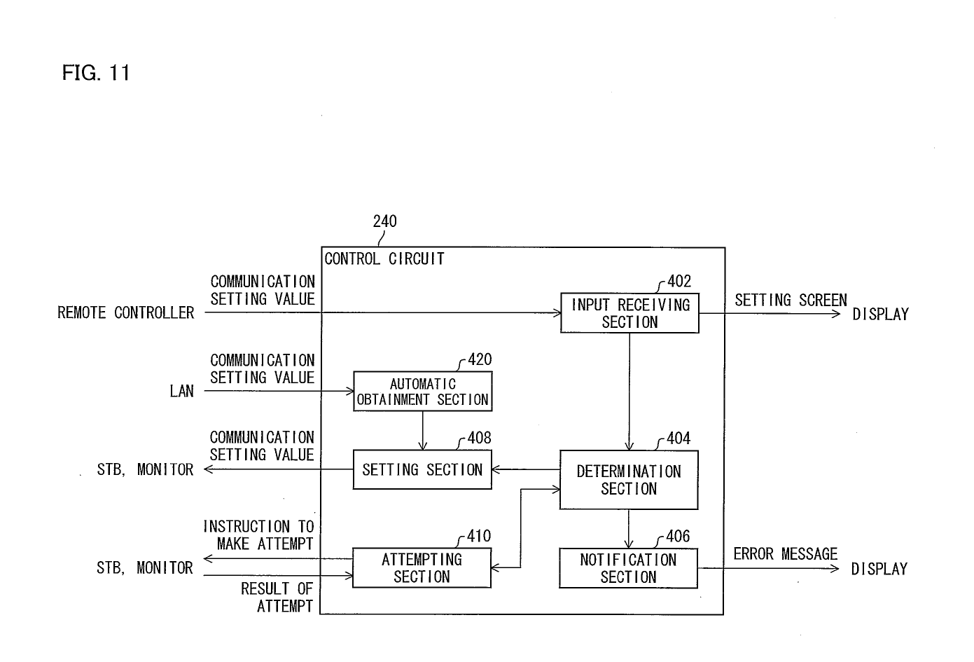

FIG. 11 is a block diagram showing a configuration of communication setting-related functions possessed by a control circuit 240 of a monitor 110 in accordance with Embodiment 2. As shown in FIG. 11, the control circuit 240 of Embodiment 2 is obtained by causing the control circuit 240 of Embodiment 1 to further include an attempting section 410.

(Attempting Section)

The attempting section 410 uses an inputted plurality of communication setting values to attempt to carry out a communication between an STB 120 and a monitor 110.

For example, the attempting section 410 temporarily sets inputted communication setting values (an IP address, a net mask, and a gateway) for each of the STB 120 and the monitor 110. In this case, the attempting section 410 instructs both or one of the STB 120 and the monitor 110 to attempt to carry out a communication.

Then, the attempting section 410 receives, from both or one of the STB 120 and the monitor 110, a signal(s) indicative of a result of the attempt to carry out the communication.

For example, the attempting section 410 causes both or one of the STB 120 and the monitor 110 to attempt to carry out the communication at a timing at which a plurality of communication setting values are inputted and the input is fixed. Alternatively, the attempting section 410 may cause both or one of the STB 120 and the monitor 110 to attempt to carry out the communication at a timing at which a plurality of communication setting values are inputted and a determination section 404 determines that the inputted plurality of communication setting values are correct. Alternatively, the attempting section 410 may cause both or one of the STB 120 and the monitor 110 to attempt to carry out the communication at any timing specified by a user.

(Determination Section)

In a case where the signal(s) received by the attempting section 410 indicates that the attempt has been normally terminated, the determination section 404 determines that inputted communication setting values are correct. In contrast, in a case where the signal(s) received by the attempting section 410 indicates that the attempt has not been normally terminated, the determination section 404 determines that the inputted communication setting values are incorrect. In a case where the determination section 404 determines that the communication setting values are incorrect (a case where the communication is discontinued), in order to allow the communication to be continued, the monitor 110 may carry out a return process by, for example, resetting what was temporarily set.

(Notification Section)

Also in a case where it is thus determined in accordance with the result of the attempt that the inputted communication setting values are incorrect, as in the case of the notification section 406 of Embodiment 1, a notification section 406 of Embodiment 2 gives notification that the inputted communication setting values are incorrect.

(Effect)

As has been described, the television receiver 100 of Embodiment 2 is configured to further determine, in accordance with a result of an attempt to carry out a communication between the STB 120 and the monitor 110, whether or not inputted communication setting values of the monitor 110 and inputted communication setting values of the STB 120 are correct.

According to this, also in a case where an actual communication connection is needed to determine whether or not inputted communication setting values are correct, the attempt to carry out the communication allows the determination. In a case where it is determined that inputted communication setting values are incorrect, by notifying a user that the inputted communication setting values are incorrect, it is possible to urge the user to correct the inputted communication setting values.

### Embodiment 3

Next, Embodiment 3 in accordance with the present invention is described below. Since a television receiver 100 of Embodiment 3 is identical to the television receiver 100 described in Embodiment 1 except for the following points, a description thereof is omitted here. The following description discusses points of difference from the television receiver 100 described in Embodiment 1.

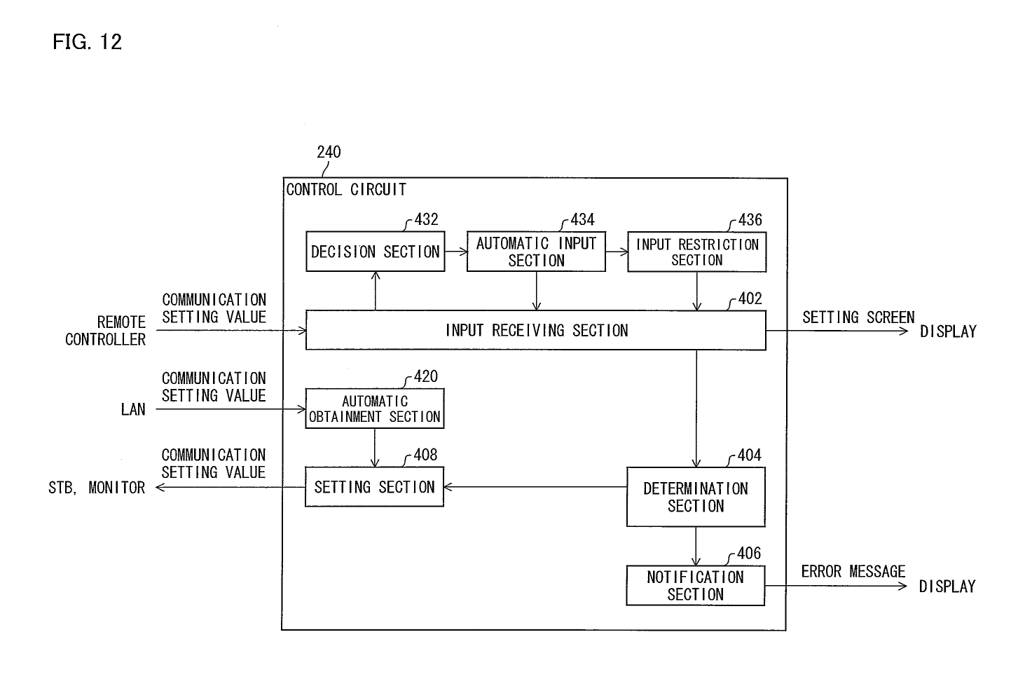

FIG. 12 is a block diagram showing a configuration of communication setting-related functions possessed by a control circuit 240 of a monitor 110 in accordance with Embodiment 3. As shown in FIG. 12, the control circuit 240 of Embodiment 3 is obtained by causing the control circuit 240 of Embodiment 1 to further include a decision section 432, an automatic input section 434, and an input restriction section 436.

(Decision Section)

The decision section 432 decides, in accordance with one or more inputted communication setting values, a communication setting value to be inputted to another communication setting item.

(Automatic Input Section)

The automatic input section 434 automatically inputs, to the another communication setting item, the communication setting value that is to be inputted to the another communication setting item and has been decided by the decision section 432.

(Input Restriction Section)

The input restriction section 436 restricts a manual input to the another communication setting item to which the communication setting value has been automatically inputted. Restriction of an input prevents the input.

(Examples of Automatic Input of Communication Setting Values)

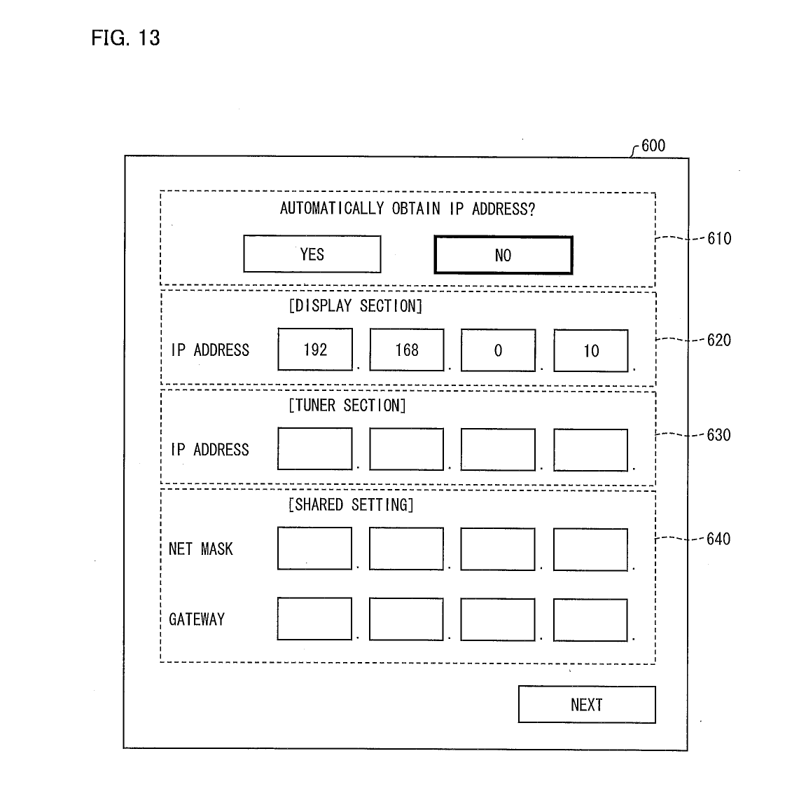

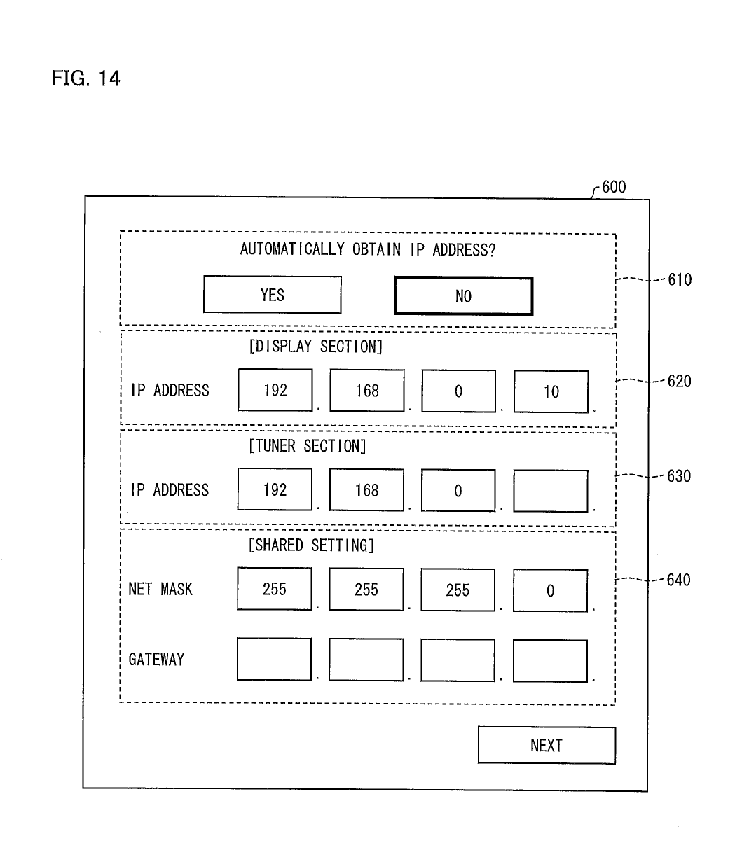

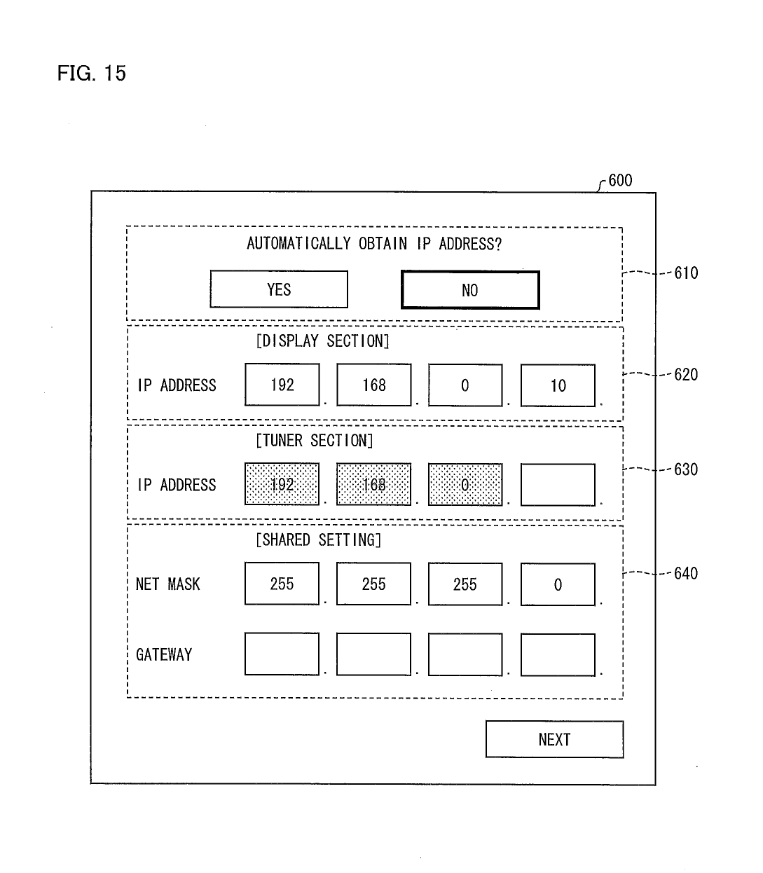

FIG. 13, FIG. 14, and FIG. 15 show respective examples of an automatic input of communication setting values.

For example, since a subnet mask is frequently used in conformity with an address class specified by RFC 791, in a case where “192.168.0.10” is inputted to an input field 620 as shown in FIG. 13, the decision section 432 determines that an address of Class C is inputted, and decides that “255.255.255.0” is a net mask. Then, as shown in FIG. 14, the net mask is automatically inputted to an input field 640 by the automatic input section 434.

Further, the decision section 432 decides in accordance with the net mask that “192.168.0” is a network address. Then, as shown in FIG. 14, the network address is automatically inputted to an input field 630 by the automatic input section 434.

Note that a network address part automatically inputted to the input field 630 is a value decided in accordance with (i) an IP address of a display section which IP address is inputted to the input field 620 and (ii) a net mask automatically inputted to the input field 640. Therefore, in a case where the decided value of the network address part in the input field 630 is changed to another setting value, the input restriction section 436 determines that the another setting value cannot be set as a correct setting value. Then, as shown in FIG. 15, the input restriction section 436 restricts the network address part in the input field 630 so that the network address part is prohibited from being manually inputted.

In a case where a user changes the address in the input field 620 to “192.168.1.10” in this state, the automatic input section 434 automatically changes, to “192.168.1”, the network address automatically inputted to the input filed 630. Further, in a case where the user changes the net mask to “255.255.0.0”, the input restriction section 436 changes, to “192.168”, a range of input restriction in the input field 630.

Note that the net mask can be changed to, for example, “255.255.254.0”. In a case where the net mask in the input field 640 is thus changed, the 24th bit of an IP address serves as a host address. Therefore, a range that can be restricted is “192.168”. This restricts, to “0” or “1”, an input value subsequent to “192.168” in the input field 630. For this reason, the input restriction section 436 allows the input value to be changed to “0” or “1”. In this case, an input may be restricted by a method in which a manual input can be carried out and the user checks, after the manual input, whether or not the in put value falls within the range, or by a method in which an interface which causes the user to select a value failing within a predetermined range is used to prevent an input of a value beyond the predetermined range.

(Another Example of Automatic Input of Communication Setting Values)

As another example of the automatic input, communication setting values used to carry out a temporary connection may be inputted in advance as recommendation values. For example, in a case where an IP address of the monitor 110 which IP address is “192.168.1.10”, an IP address of the STB 120 which IP address is “192.168.1.11”, and a net mask which is “255.255.255.0” are used to carry out the temporary connection, these communication setting values may be automatically inputted in advance to respective corresponding input fields. Alternatively, the automatic input may be carried out by a method in which a network address of “192.168.1” decided in accordance with the net mask is set for each of the input field 620 and the input field 630 and a user inputs only respective host addresses of the input field 620 and the input field 630.

(Still Another Example of Automatic Input of Communication Setting Values)

The following description discusses still another example of the automatic input. Assuming that no other device is connected with a LAN 10, it is possible to set any address. Therefore, the television receiver 100 may include means for automatically inputting a set of IP addresses and a net mask each stored in a memory as a recommendation value, e.g., “192.169.0.10”, “192.168.0.11”, “255.255.255.0”. In this case, the input restriction described earlier may be applied to such communication setting values, so that a user can set communication setting values without the need of inputting the communication setting values. Alternatively, the automatic input may be carried out by a method in which only a part (e.g., a network address part) of an IP address which part does not need to be changed in many cases is inputted in advance and the other part is inputted by the user.

(Effect)

As has been described, the television receiver 100 of Embodiment 3 is configured to (i) decide, in accordance with one or more inputted communication setting values, a communication setting value to be inputted to another communication setting item, and (ii) automatically input, to the another communication setting item, the decided communication setting value to be inputted to the another communication setting item.

This allows a significant reduction in occurrence of a trouble to a user and/or an input error made by the user.

Further, the television receiver 100 of Embodiment 3 is configured to restrict a manual input to another communication setting item to which a communication setting value has been automatically inputted.

This securely eliminates an input error made by a user such that the user erroneously rewrites an automatically inputted communication setting values. Further, the user can easily determine which communication setting items may be subjected to a manual input.

(Program and Recording Medium)

Each function of the television receiver 100 described in the embodiments may be realized by a logic circuit formed on an integrated circuit (IC chip) by means of hardware. Alternatively, the each function may also be realized by a CPU (Central Processing Unit) by means of software.

For example, the television receiver 100 includes (i) a CPU which executes a command of a program that carries out the each function of the television receiver 100, (ii) a ROM (Read Only Memory) in which the program is stored, (iii) a RAM (Random Access Memory) which extracts the program, and (iv) a storage device (a recording medium) such as a memory in which the program and various sets of data are stored. The each function of the television receiver 100 can be realized by causing the CPU to read and execute the program stored in the storage device.

Examples of the recording medium encompass (i) tapes such as a magnetic tape and a cassette tape, (ii) disks including magnetic disks such as a Floppy (Registered Trademark) disk and a hard disk, and optical disks such as a CD-ROM, an MO, an MD, a DVD, and a CD-R, (iii) cards such as an IC card (including a memory card) and an optical card, (iv) semiconductor memories realized by, for example, a mask ROM, EPROM, EEPROM, and a flash ROM, (v) logic circuits such as a PLD (Programmable Logic Device) and an FPGA (Field Programmable Gate Array), and (vi) the like.

Note that the program may be supplied to the television receiver 100 via a communication network. The communication network may be of any type provided that the communication network can transmit at least the program to the television receiver 100. Examples of the communication network encompass the Internet, an intranet, an extranet, a LAN, ISDN, VAN, a CATV communication network, a virtual private network, a telephone network, a mobile telecommunications network, and a satellite communication network.

Note also that a transmission medium for supplying the program to the television receiver 100 may also be of any type. The transmission medium is exemplified by wired transmission media such as IEEE 1394, a USB, a power-line carrier, a cable TV circuit, a telephone line, and ADSL (Asymmetric Digital Subscriber Line). The transmission medium is also exemplified by wireless transmission media such as infrared communication systems such as IrDA and a remote controller, Bluetooth (Registered Trademark), IEEE 80211 wireless communication system, HDR (High Data Rate), NFC (Near Field Communication), DLNA, a mobile phone network, a satellite circuit, and a digital terrestrial network.

(Supplementary Explanation)

The present invention is not limited to the descriptions of the respective embodiments, but may be altered within the scope of the claims. An embodiment derived from a proper combination of technical means disclosed in different embodiments is encompassed in the technical scope of the invention.

(Target to which the Present Invention is Applicable)

The embodiments each discuss an example in which the present invention is applied to a television receiver. However, the present invention is also applicable to a device and a system other than the television receiver provided that the device or the system includes at least a plurality of communication devices. For example, the present invention is also applicable to (i) a communication system which includes a television, a tuner, a monitor, a recorder, a PC, a mobile terminal, a server, a printer, a scanner, a home appliance, a surveillance camera, and the like as communication devices and (ii) an audio system which includes an amplifier, a speaker, and the like as communication devices.

The embodiments each discuss an example in which a communication setting is carried out with respect to a LAN. However, the present invention is also applicable to a case where a communication setting is carried out with respect to a communication network other than the LAN.

The embodiments each discuss an example in which a communication setting is carried out with respect to an IP address, a net mask, and a gateway server. However, the present invention is also applicable to a case where a communication setting is carried out with respect to a communication setting item other than these communication setting items.

The embodiments each discuss an example in which a communication setting is carried out with respect to two communication devices included in a television receiver. However, the present invention is also applicable to a case where a communication setting is carried out with respect to three or more communication devices.

The embodiments each discuss an example in which a television receiver includes only one of a plurality of communication devices which can be subjected to a communication setting, the plurality of communication devices communicating with each other. However, the television receiver may be configured to include a plurality of communication devices each of which can be subjected to a communication setting. In this case, it is only necessary for a user to carry out a communication setting for each of the plurality of communication devices with use of any one of the plurality of communication devices each of which can be subjected to a communication setting.

According to the embodiments, in a case where it is determined that an inputted communication setting value is incorrect, an error message is displayed to notify a user that the inputted communication setting value is incorrect. However, another notification method such as sounding of an alarm may also be used to notify the user that the inputted communication setting value is incorrect.

Embodiment 3 discusses an example in which communication setting values to be set for respective communication setting items are automatically inputted to the respective communication setting items. However, in order to urge a user to input the communication setting values, the communication setting values may be displayed in a screen without being automatically inputted.

### CONCLUSION

As has been described, a communication device in accordance with the present embodiment is a communication device capable of communicating with another communication device via a communication network, the communication device including: input receiving means for causing a single setting screen to receive an input of a communication setting value of the communication device and an input of a communication setting value of the another communication device; and setting means for setting the inputted communication setting value of the communication device for the communication device, and setting the inputted communication setting value of the another communication device for the another communication device.

The communication device allows a single communication device to carry out a communication setting with respect to a plurality of communication devices including the single communication device. Therefore, the user, who does not need to operate the plurality of communication devices and a plurality of user interfaces, can carry out the communication setting with respect to the plurality of communication devices without taking trouble and time. In particular, also in a case where the another communication device has no user interface, it is unnecessary to separately prepare and operate another device for carrying out a communication setting with respect to the another communication device, it is possible to carry out the communication setting with respect to the plurality of communication devices without taking trouble, time, and cost. Further, since the single communication device can collectively carry out a change in communication setting with respect to the plurality of communication devices, it is possible to prevent occurrence of a problem such that a communication setting for only one of the plurality of communication devices is changed and the plurality of communication devices cannot communicate with each other.

In particular, since the communication device allows a single setting screen to carry out the communication setting with respect to a plurality of communication devices, it is possible to understand the communication setting for the plurality of communication devices at a glance. For example, there may be a case where in order to carry out a plurality of communication settings, a user may need to input appropriate values while comparing a plurality of communication setting values of the plurality of communication devices such as setting values that need to be identical to each other (e.g., network addresses) and setting values that need to be different from each other (e.g., host addresses). Also in this case, the user can easily make such a comparison without the need of carrying out a an operation which takes trouble and time, and easily causes an error, such as switching of a plurality of screens or notetaking.

The communication device is preferably configured such that the input receiving means is configured to cause the single setting screen to receive an input of a shared communication setting value which is shared by a communication setting carried out with respect to the communication device and a communication setting carried out with respect to the another communication device; and the setting means is configured to set the inputted shared communication value for each of the communication device and the another communication device.

This configuration makes it possible to save a user from inputting the shared communication setting value a plurality of times and to prevent a setting error such that the plurality of communication devices differ in communication setting value that is supposed to be shared.

The communication device is preferably configured such that the shared communication setting value is at least one of a network address of an IP address, a net mask, and a gateway address.

In particular, while being important communication settings which are shared by the plurality of communication devices, the network address of an IP address, the net mask, and the gateway address are communication settings that take trouble and easily cause an input error. According to this configuration, also in such communication settings, a setting error can be eliminated while the user is saved from taking the trouble.

Note that the shared communication setting value is not limited to the above. The shared communication setting value may be, for example, an address of a DNS server.

Further, it is preferable that the communication device further includes: determination means for determining, in accordance with one or more inputted communication setting values, whether or not another inputted communication value is correct; and notification means for, in a case where it is determined by the determination means that the another communication setting value is incorrect, notifying that the another communication setting value is incorrect.

There may be a case where the another communication setting value is restricted within a given range in accordance with one or more communication setting values. According to the configuration, also in a case where a value beyond the range is incorrectly inputted as the another communication setting value, without the need of attempting to carry out a communication connection, it is possible to urge a user to correct the inputted communication setting value.

Further, it is preferable that the communication device further includes: attempting means for attempting to communicate with the another communication device with use of the inputted communication setting value of the communication device and the inputted communication setting value of the another communication device, the determination means being configured to further determine, in accordance with a result of the attempt to communicate with the another communication device, whether or not the inputted communication setting value of the communication device and the inputted communication setting value of the another communication device are correct.

According to the configuration, also in a case where an attempt to carry out an actual communication connection is needed to determine whether or not the inputted communication setting value is correct, the attempt to carry out the communication allows the determination. In a case where it is determined that the inputted communication setting value is incorrect, by notifying a user that the inputted communication setting value is incorrect, it is possible to urge the user to correct the inputted communication setting value.

Further, it is preferable that the communication device further includes: decision means for deciding, in accordance with one or more inputted communication setting values, a communication setting value to be inputted to another communication setting item; and automatic input means for automatically inputting, to the another communication setting item, the decided communication setting value to be inputted to the another communication setting item.

There may be a case where the communication setting value to be inputted to another communication setting item is determined in accordance with one or more inputted communication setting values. The configuration allows the communication device to (i) automatically decide the communication setting value to be inputted to another communication setting item and (ii) automatically input, to the another communication setting item, the decided communication setting value. This allows a significant reduction in occurrence of a trouble to a user and/or an input error made by the user.

Further, it is preferable that the communication device further includes manual input restriction means for restricting a manual input to the another communication setting item to which the communication setting value has been automatically inputted.

This configuration securely eliminates an input error made by a user such that the user erroneously rewrites an automatically inputted communication setting value. Restriction of an input to the communication setting item to which a communication setting value has been automatically inputted also indicates, to a user, a communication setting item which may be subjected to a manual input. This enables a user to easily understand, without being at a loss, which communication setting item may be subjected to a manual input.

Further, a television receiver in accordance with the present embodiment includes the communication device.

The television receiver of the present invention can bring about an effect identical to that brought about by the communication device.

Further, a communication system in accordance with the present embodiment is a communication system including a plurality of communication devices which are capable of communicating with each other via a communication network, the plurality of communication devices including at least one communication device including: input receiving means for causing a single setting screen to receive an input of a communication setting value of the at least one communication device and an input of a communication setting value of another communication device; and setting means for setting the inputted communication setting value of the at least one communication device for the at least one communication device, and setting the inputted communication setting value of the another communication device for the another communication device.

The communication system makes it possible to bring about an effect identical to that brought about by the communication device.

Further, a communication setting method in accordance with the present embodiment is a communication setting method carried out by a communication device capable of communicating with another communication device via a communication network, the communication setting method including: an input receiving step of causing a single setting screen to receive an input of a communication setting value of the communication device and an input of a communication setting value of the another communication device; and a setting step of setting the inputted communication setting value of the communication device for the communication device, and setting the inputted communication setting value of the another communication device for the another communication device.

The communication setting method can bring about an effect identical to that brought about by the communication device by being executed by a communication device.

Further, a program in accordance with the present embodiment is a program for causing a computer to function as the communication device, the program causing the computer to function as each means of the communication device.

The program can bring about an effect identical to that brought about by the communication device by being executed by a computer.

Further, a recording medium in accordance with the present embodiment is a computer-readable recording medium in which the program is recorded.

The recording medium can provide the program which brings about an effect identical to that brought about by the communication device.

### INDUSTRIAL APPLICABILITY

The present invention can be applicable to a communication device capable of communicating with another communication device; a television receiver which includes the communication device; a communication system including a plurality of communication devices each including the communication device; a communication setting method for carrying out a communication setting with respect to each of the plurality of communication devices each including the communication device; a program to cause a computer to function as the communication device; and a recording medium in which the program can be recorded so as to be computer-readable.

### REFERENCE SIGNS LIST

10 LAN (communication network)
100 television receiver
110 monitor (communication device)
120 STB (other communication device)
219 display
250 remote controller
240 control circuit
402 input receiving section (input receiving means)
404 determination section (determination means)
406 notification section (notification means)
408 setting section (setting means)
410 attempting section (attempting means)
420 automatic obtainment section
432 decision section (decision means)
434 automatic input section (automatic input means)
436 input restriction section (input restriction means)

1-12. (canceled)

13. A communication device capable of communicating with another communication device via a communication network, the communication device comprising:
input receiving means for receiving an input of a communication setting value related to a communication between the communication device and the another communication device, and causing a single setting screen to receive an input of a communication setting value of the communication device and an input of a communication setting value of the another communication device; and
setting means for setting the inputted communication setting value of the communication device for the communication device, and setting the inputted communication setting value of the another communication device for the another communication device.

14. The communication device according to claim 13, wherein:
the input receiving means is configured to cause the single setting screen to receive an input of a shared communication setting value which is shared by a communication setting carried out with respect to the communication device and a communication setting carried out with respect to the another communication device; and
the setting means is configured to set the inputted shared communication value for each of the communication device and the another communication device.

15. The communication device according to claim 14, wherein the shared communication setting value is at least one of a network address of an IP address, a net mask, and a gateway address.

16. A communication device according to claim 13, further comprising:
determination means for determining, in accordance with one or more inputted communication setting values, whether or not another inputted communication value is correct; and
notification means for, in a case where it is determined by the determination means that the another communication setting value is incorrect, notifying that the another communication setting value is incorrect.

17. A communication device according to claim 16, further comprising:
attempting means for attempting to communicate with the another communication device with use of the inputted communication setting value of the communication device and the inputted communication setting value of the another communication device,
the determination means being configured to further determine, in accordance with a result of the attempt to communicate with the another communication device, whether or not the inputted communication setting value of the communication device and the inputted communication setting value of the another communication device are correct.

18. A communication device according to claim 13, further comprising:
decision means for deciding, in accordance with one or more inputted communication setting values, a communication setting value to be inputted to another communication setting item; and
automatic input means for automatically inputting, to the another communication setting item, the decided communication setting value to be inputted to the another communication setting item.

19. A communication device according to claim 18, further comprising manual input restriction means for restricting a manual input to the another communication setting item to which the communication setting value has been automatically inputted.

20. A television receiver comprising a communication device recited in claim 13.

21. A communication system comprising a plurality of communication devices which are capable of communicating with each other via a communication network,
the plurality of communication devices including at least one communication device including:
input receiving means for receiving an input of a communication setting value related to a communication between the at least one communication device and another communication device, and causing a single setting screen to receive an input of a communication setting value of the at least one communication device and an input of a communication setting value of the another communication device; and
setting means for setting the inputted communication setting value of the at least one communication device for the at least one communication device, and setting the inputted communication setting value of the another communication device for the another communication device.

22. A communication setting method carried out by a communication device capable of communicating with another communication device via a communication network, the communication setting method comprising:
an input receiving step of receiving an input of a communication setting value related to a communication between the communication device and the another communication device, and causing a single setting screen to receive an input of a communication setting value of the communication device and an input of a communication setting value of the another communication device; and
a setting step of setting the inputted communication setting value of the communication device for the communication device, and setting the inputted communication setting value of the another communication device for the another communication device.

23. A non-transitory computer-readable recording medium in which a program for operating a computer as a communication device as set forth in claim 13 is recorded, the program causing the computer to function as each means of the communication device.
